(19) United States
(12) Patent Application Publication
(10) Pub. No.: US 2010/0257319 A1
(43) Pub. Date: Oct. 7, 2010

(54) CACHE SYSTEM, METHOD OF CONTROLLING CACHE SYSTEM, AND INFORMATION PROCESSING APPARATUS

(75) Inventor: Hiroyuki USUI, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/718,378

(22) Filed: Mar. 5, 2010

(30) Foreign Application Priority Data
Apr. 7, 2009 (JP) 2009-092855

(51) Int. Cl. G06F 12/08; G06F 12/00

(52) U.S. Cl. 711/130; 711/163; 711/141; 711/E12.001; 711/E12.038; 711/E12.026; 711/E12.093

(57) ABSTRACT

A cache system can change a cache capacity in a unit of a plurality of divided memory areas. Cache access to at least one memory area among the divided memory areas is restricted in the debug mode. Access history information concerning access in the debug mode is stored in the memory area to which the cache access is restricted.

### CROSS-REFERENCE TO RELATED APPLICATIONS

This application is based upon and claims the benefit of priority from the prior Japanese Patent Application No. 2009-092855, filed on Apr. 7, 2009; the entire contents of which are incorporated herein by reference.

### BACKGROUND OF THE INVENTION

1. Field of the Invention

The present invention relates to a cache system, a method of controlling the cache system, and an information processing apparatus.

2. Description of the Related Art

As a multi-core architecture including a plurality of processor cores, for example, there is a system in which a plurality of cores share a cache memory. When the cores simultaneously access the cache memory, if data is updated by a certain core, inconsistency of the data occurs between the core and the other cores that have the data before the update. As means for coping with the inconsistency of the data occurred in this way, there is control of cache coherency for securing consistency of the data.

When the cache coherency is realized by a hardware configuration, the system is increased in size, cost increases because of an increase in access latency, and performance is deteriorated. When the cache coherency is realized by software, debugging is extremely difficult if there is a deficiency in operation, for example, a protocol is not observed. In particular, as the number of cores included in the multi-core architecture is larger, an amount of information concerning access to a shared resource increases. Therefore, it is difficult to secure a storage destination of data necessary for the debugging and data transfer speed does not catch up with the increase in the amount of access history information. When it is attempted to support the treatment of the access history information with a hardware configuration, eventually, cost increases.

For example, Japanese Patent Application Laid-Open No. H5-165675 discloses a technique for a debug supporting device including means for collecting data necessary for debugging in a configuration in which a plurality of processors share a memory. In such a technique, transfer of the data via a main bus is necessary to collect the data with the collecting means. Therefore, time required for execution of the debugging increases.

### BRIEF SUMMARY OF THE INVENTION

A cache system according to an embodiment of the present invention comprises: a history creating unit that creates access history information concerning access in a debug mode, wherein in the debug mode, cache access to at least one memory area among the divided memory areas is restricted and the access history information is stored in the memory area to which the cache access is restricted.

A method of controlling a cache system according to an embodiment of the present invention comprises: creating access history information concerning access in a debug mode, wherein in the debug mode, cache access to at least one memory area among the divided memory areas is restricted and the access history information is stored in the memory area to which the cache access is restricted.

An information processing apparatus according to an embodiment of the present invention comprises: a cache system that can change a cache capacity in a unit of a plurality of divided memory areas, wherein the cache system includes a history creating unit that creates access history information concerning access in a debug mode, wherein in the debug mode, cache access to at least one memory area among the divided memory areas is restricted and the access history information is stored in the memory area to which the cache access is restricted.

### BRIEF DESCRIPTION OF THE DRAWINGS

FIG. 1 is a block diagram of the configuration of a processor system that is an information processing apparatus according to a first embodiment of the present invention;

FIG. 2 is a diagram of an example of positions of a bit representing a tag and a bit representing an index in an address;

FIG. 3 is a diagram of a structure example of an index generator;

FIG. 4 is a diagram of a format for one word of a tag memory;

FIG. 5 is a diagram of a format for one word of a data memory 1 in a debug mode;

FIG. 6 is a block diagram of the configuration of a processor system including a cache system according to a second embodiment of the present invention;

FIG. 7 is a diagram of an example of the internal structure of a target storing unit;

FIG. 8 is a diagram of a format for one word of the data memory 1 in the debug mode;

FIG. 9 is a block diagram of the configuration of a processor system including a cache system according to a third embodiment of the present invention;

FIG. 10 is a diagram of a format for one word of the data memory 1 in the debug mode; and

FIG. 11 is a diagram of a format for one word in saving access history information from the data memory 1.

### DETAILED DESCRIPTION OF THE INVENTION

Exemplary embodiments of cache system, method of controlling cache system, and information processing apparatus according to the present invention will be explained below in detail with reference to the accompanying drawings. The present invention is not limited to the following embodiments.

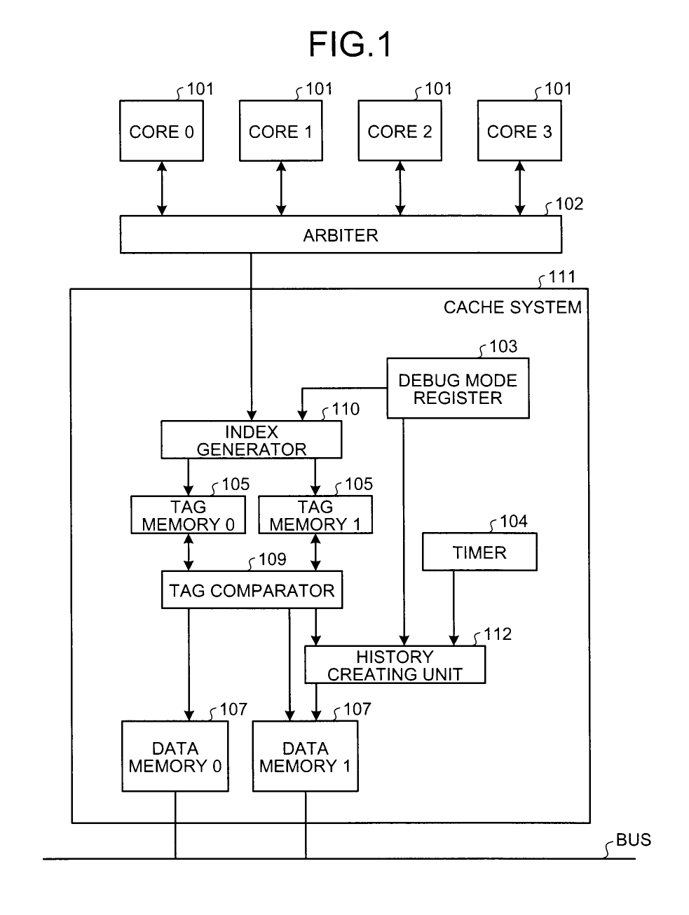

FIG. 1 is a block diagram of the configuration of a processor system that is an information processing apparatus according to a first embodiment of the present invention. The processor system includes a plurality of processor cores 101 (in this embodiment, for example, four corers 0 to 3), an arbiter 102, and a cache system 111. The cache system 111 is shared by the processor cores 101.

The processor cores 101 are central processing units (CPUs) for controlling the operation of the processor system. The processor cores 101 execute a computer program stored in a main memory (not shown). When accesses from the processor cores 101 to the cache system 111 conflict with one another, the arbiter 102 allocates the accesses according to a specified method. The cache system 111 is connected to the main memory and the like via a bus.

The cache system 111 includes a debug mode register 103, a timer 104, a tag memory 105, a tag comparator 109, a data memory 107, an index generator 110, and a history creating unit 112. The tag memory 105 stores a tag in cache line units. The tag comparator 109 compares a tag of an address of cache access to the cache system 111 and tag information read out from the tag memory 105. The data memory 107 stores data in cache line units.

The cache system 111 can dynamically change a cache capacity in a unit of memory areas obtained by dividing a memory area having a maximum capacity into a plurality of (in this embodiment, two) memory areas. The tag memory 105 is divided into a tag memory 0 to which a former half of an index is allocated and a tag memory 1 to which a latter half of the index is allocated. The data memory 107 is divided into a data memory 0 to which the former half of the index is allocated and a data memory 1 to which the latter half of the index is allocated.

The index generator 110 functions as index generating unit for generating an index as a target of cache access according to an address accessed from the processor cores 101. The debug mode register 103 indicates whether the cache system 111 is in a debug mode for executing debugging. The timer 104 manages the present time. The history creating unit 112 functions as history creating unit for creating access history information concerning accesses from the processor cores 101 in the debug mode.

It is assumed that an address space in the processor system explained in this embodiment is a 32-bit space (byte address) and access from the processor cores 101 is access in 64-byte units. The cache system 111 adopts, for example, a four-way set associative system. It is assumed that a cache size of the cache system 111 is 4 megabytes and a line size thereof is 256 bytes.

The configuration explained in this embodiment can be modified as appropriate based on the gist of the following explanation by engineers in the field to which the present invention belongs. For example, the number of processor cores 101 is not limited to four and only has to be equal to or larger than one. The number of divisions of the memory area of the cache system 111 is not limited to two and only has to be equal to larger than two, for example, can be four. The cache system 111 can be modified to cache systems that adopt association degrees of all of a set associative system other than the four-way set associative system, a full associative system, and a direct map system. Therefore, the following explanation should be broadly understood as content disclosed concerning the field and does not limit the present invention.

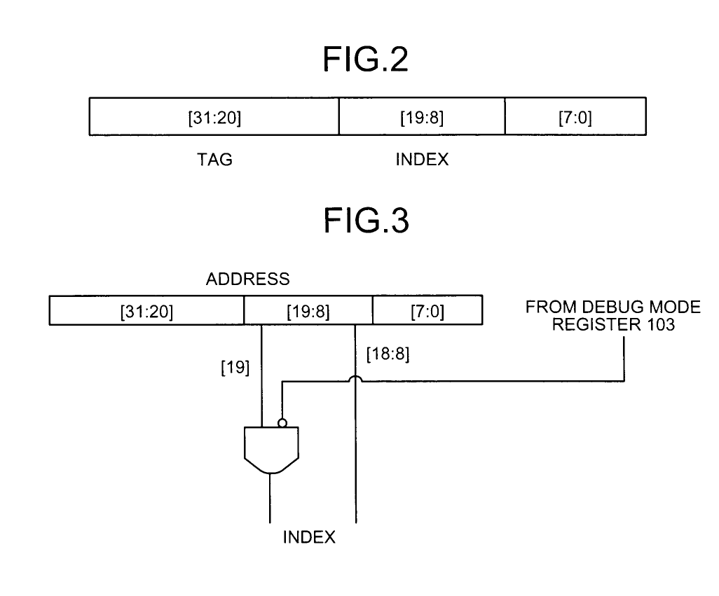

FIG. 2 is a diagram of an example of positions of a bit representing a tag and a bit representing an index in an address. In this embodiment, as the index, 12 bits from an eighth bit to a nineteenth bit of the address are used. As the tag, 12 bits from a twentieth bit to a thirty-first bit are used.

In a normal mode, “0” is set in the debug mode register 103. The normal mode is a mode other than the debug mode and refers to a mode for causing software to operate on the processor system. When a deficiency occurs in execution of the software in the normal mode, “1” is set in the debug mode register 103. Debugging is started by executing the software again in a state in which “1” is set in the debug mode register 103.

FIG. 3 is a diagram of a structure example of the index generator 110. In the normal mode in which a value of the debug mode register 103 is “0”, the eighth to nineteenth bits of the address accessed from the processor cores 101 are directly output as the index. From the tag memory 105, tags of respective ways are read out concerning the accessed index. The tag of the accessed address and the tags read out from the tag memory 105 are compared with the tag comparator 109. The data memory 107 is accessed according to a comparison result of the tag comparator 109. In the normal mode, all tag memories 0 and 1 and data memories 0 and 1 are set as targets of cache access.

In the debug mode in which a value of the debug mode register 103 is “1”, the most significant nineteenth bit among the 12 bits from the eighth bit to nineteenth bit of the address accessed from the processor cores 101 is fixed to “0”. The index generator 110 outputs, as an index, the eighth to eighteenth bits of the accessed address and the nineteenth bit fixed to “0”.

Because the most significant bit of the 12 bits is fixed to “0”, a range of the index indicates 0 to 2047, i.e., a former half of a normal range. Consequently, in the debug mode, cache access to the tag memory 0 and the data memory 0 to which the former half of the index is allocated in the memory area is performed. Cache access to the tag memory 1 and the data memory 1 to which the latter half of the index is allocated is restricted. In the debug mode, the index generator 110 generates an index in which memory areas other than memory areas to which cache access is restricted are set as targets of the cache access.

The cache system 111 uses the tag memory 1 and the data memory 1, which are the memory areas to which cache access is restricted, for storage of access history information. The structure of the index generator 110 explained above is an example in which debug history information is stored in one of the divided two memory areas. The structure can be modified as appropriate according to a cache capacity allocated to debugging.

The operation of the cache system 111 in the debug mode is explained with reference to an example in which the core 0 of the processor cores 101 accesses an address “0x450f_{—}6a00”. An index of the address “0x450f_{—}6a00” is “0x76a” when a most significant bit of 12 bits “0xf6a” from an eighth bit to a nineteenth bit changes to “0”. A tag of the index “0x76a” is read out from the tag memory O. Simultaneously with the readout of the tag from the tag memory 0, a tag of an index “0xf6a” in the normal mode is read out from the tag memory 1. The index “0xf6a” in the tag memory 1 and the index “0x76a” in the tag memory 0 are located in same positions in the memory areas as a unit and are in a correspondence relation. In the debug mode, the tag increases by 1 bit from that in the normal mode to be 13 bits.

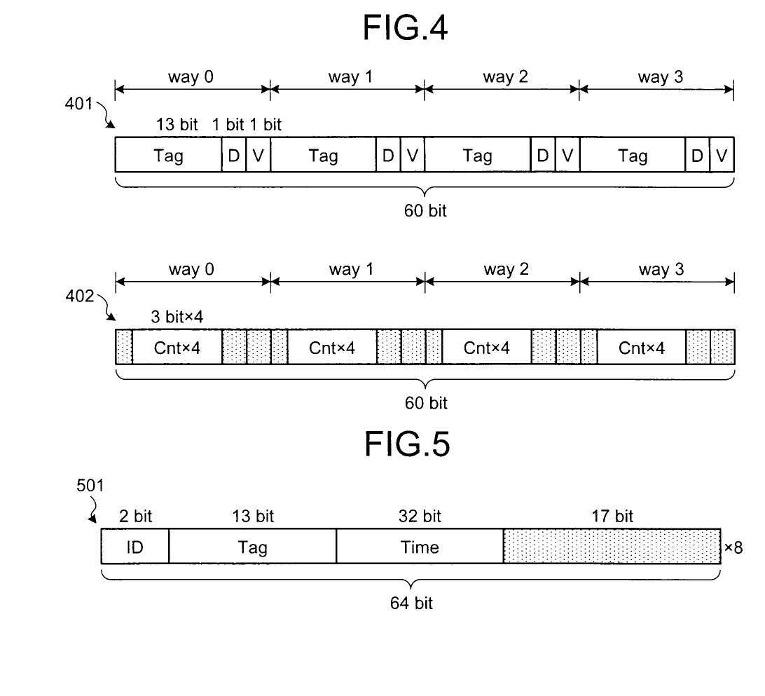

FIG. 4 is a diagram of formats 401 and 402 for one word (a unit of one access) of the tag memory 105. In the format 401 in the normal mode, for each of ways, 13 bits are secured as tag bits, 1 bit is secured as a dirty (D) bit, and 1 bit is secured as a valid (V) bit. The tag bits indicate a tag of a cache line. The dirty bit indicates whether it is necessary to write data of the cache line back to a memory in a lower order hierarchy when the data of the cache line is updated. The valid bit indicates whether stored data is valid as a tag. 13 bits are secured as the tag bits according to the number of bits in the debug mode. The format 401 includes 60 bits in total with 15 bits allocated to each of the ways.

In the format 402 in the debug mode, a plurality of counters (Cnt) are secured for each of the ways. In this embodiment, for example, four counters 0 to 3 are secured in the format 402. For example, 3 bits are allocated to each of the counters. The counter counts the number of pieces of access history information stored in a field explained below. Among the 60 bits, 15 bits are allocated to each of the ways. Among the 15 bits allocated to each of the ways, 3 bits other than 12 bits (3 bits×4) allocated as the counter are not used.

The tag comparator 109 compares a tag of an accessed address and a tag concerning each of the ways read out from the tag memory 0. As a result of the comparison by the tag comparator 109, for example, when the way 0 hits, cache data in an access address determined by an index number and a way number in the data memory 0 is accessed. It is assumed that a unit of access to the data memory 107 is, for example, 512 bits. Simultaneously with the access to the data memory 0, debug history information is written in the data memory 1. An access address in which the debug history information is written in the data memory 1 and the accessed access address in the data memory 0 are located in same positions in a memory area as a unit and are in a correspondence relation.

FIG. 5 is a diagram of a format 501 for one word (a unit of one access) of the data memory 1 in the debug mode. The format 501 includes a plurality of fields. In this embodiment, the format 501 includes, for example, eight fields 0 to 7. For example, 64 bits are allocated to each of the fields. In each of the fields, 2 bits are secured as ID bits, 13 bits are secured as tag bits, and 32 bits are secured as time bits.

The ID bits are bits for identifying the processor cores 101 at access sources. In this embodiment, to identify the four processor cores 101 (0 to 3), 2 bits are secured as the ID bits. The tag bits indicate a tag currently being accessed. The time bits indicate a numerical value of the timer 104 at the time of access. The number of time bits is set the same as the number of bits of the timer 104, for example, 32 bits. The history creating unit 112 creates, as debug history information, data of the ID bits, the tag bits, and the time bits in response to setting of a value of the debug mode register 103 to “1”. Among the 64 bits of each of the fields, the remaining 17 bits are set as invalid bits.

A field in which the debug history information is written among the eight fields included in the format 501 is determined by sixteen counters included in the format 402 (see FIG. 4) read out from the tag memory 1. In an example explained here, because the way 0 is accessed, first, four counters allocated to the way 0 among the sixteen counters are selected. The positions of the four counters indicate positions in access units of 64 byte from the processor cores 101. The positions in access units in a cache line are indicated by 2 bits of a sixth bit and a seventh bit in an address accessed from the processor cores 101.

In the example, because 2 bits of a sixth bit and a seventh bit in an address “0x450f_{—}6a00” are “0x0”, a zeroth counter 0 among the four counters is selected. When a value of the counter 0 of the way 0 is “0”, access history information is written in a zeroth field 0. As the ID bits, “0x0” indicating the core 0 among the four processor cores 101 is written.

As the tag bit, 13 bits “0x8a1” obtained by adding “1” of the original nineteenth bit to the lower order of 12 bits “0x450” from a twentieth bit to a thirty-first bit of the address “0x450f_{—}6a00” is written. As the time bit, a numerical value of the timer 104 is written. Simultaneously with the writing of the access history information, the value of the counter 0 of the way 0 is incremented from “0” to “1”. In both the cases of a hit and a cache miss of cache access, the access history information is written and the value of the counter is incremented.

It is assumed that the core 2 accesses the same address “0x450f_{—}6a00” following the access by the core 0 explained above. In this case, as in the case explained above, the way 0 hits. Therefore, an access address same as that accessed by the core 0 in the data memory 1 is accessed. Because the value of the counter 0 of the way 0 is “1”, the access history information is written in a first field 1. As the ID bits, “0x2” indicating the core 2 among the four processor cores 101 is written. As the tag bit, “0x8a1” same as that in the case of the core 0 is written. As the time bit, a numerical value of the timer 104 is written. Simultaneously with the writing of the access history information, the value of the counter 0 of the way 0 is incremented from “1” to “2”.

It is assumed that the core 1 accesses an address “0x1347_{—}6a00” following the access by the core 2 explained above. In the address “0x1347_{—}6a00”, a most significant bit among 12 bits “0x76a” from an eighth bit to a nineteenth bit does not change from “0”. Therefore, as in the case of the access to the address “0x450f_{—}6a00”, an index is “0x76a”.

It is assumed that, as a result of comparing a tag of an accessed address and tags concerning the ways read out from the tag memory 0, for example, replacing of the way 0 occurs because of a cache miss. In this case, the way 0 in an access address same as that in the access to the address “0x1347_{—}6a00” in the data memory 1 is accessed. Because a value of the counter 0 of the way 0 is “2”, access history information is written in a second field 2. As the ID bits, “0x1” indicating the core 1 among the four processor cores 101 is written.

As the tag bit, 13 bits “0x268” obtained by adding “0” of the original nineteenth bit to the lower order of 12 bits “0x134” from a twentieth bit to a thirty first bit of the address “0x1347_{—}6a00” is written. As the time bit, a numerical value of the timer 104 is written. Simultaneously with the writing of the access history information, the value of the counter 0 of the way 0 is incremented from “2” to “3”.

The cache system 111 according to this embodiment can store access history information of the latest eight times of access for each of the fields of 64 byte in the data memory 1 by repeating the operation explained above. The stored access history information can be utilized for debugging of software. The cache system 111 according to this embodiment can prevent an increase in execution time due to data transfer by storing the access history information in the cache system 1 simultaneously with cache access.

It is unnecessary to separately prepare a component for storage of the access history information. Therefore, it is also possible to suppress an increase in size of the system and an increase in cost due to an increase in access latency. Consequently, there is an effect that it is possible to suppress an increase in cost and reduce time required for execution of debugging. The cache system 111 only has to restrict cache access to at least one of a plurality of divided memory areas and enables cache access to the other memory areas. The cache system 111 can be modified as appropriate according to the number of divisions of the memory area.

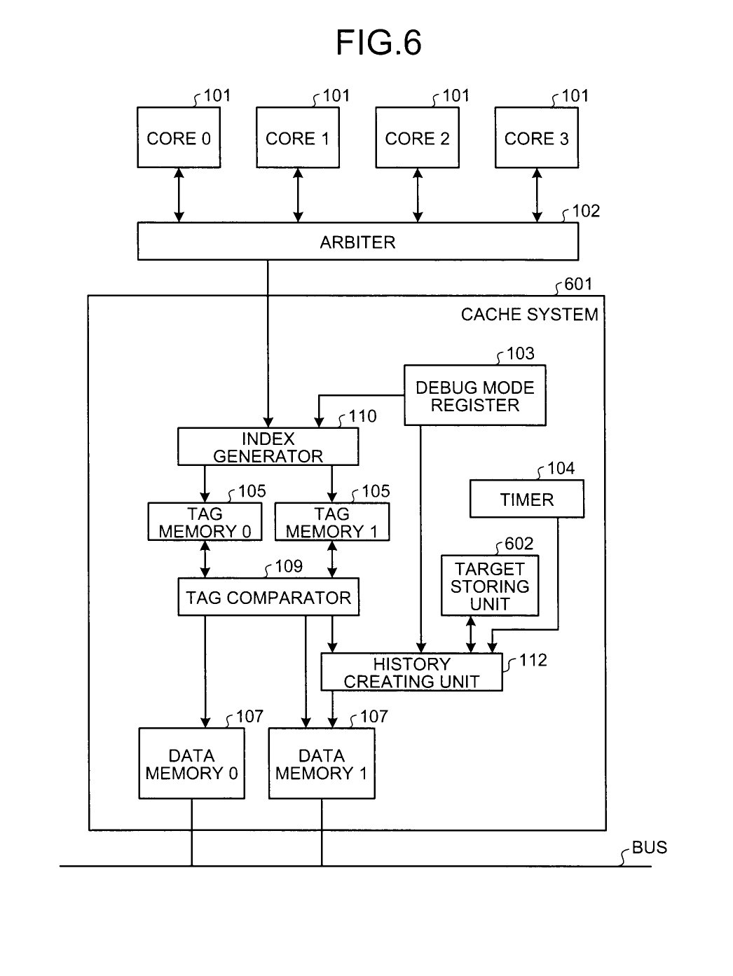

FIG. 6 is a block diagram of the configuration of a processor system including a cache system 601 according to a second embodiment of the present invention. In the cache system 601 according to this embodiment, access history information is stored in response to access to addresses set as targets. Components same as those in the first embodiment are denoted by the same reference numerals and signs and redundant explanation is omitted. A target storing unit 602 stores the addresses set as the targets. For example, when a deficiency occurs because of execution of software in the normal mode and addresses in which bugs are seemed to occur are narrowed down, the addresses are set as targets.

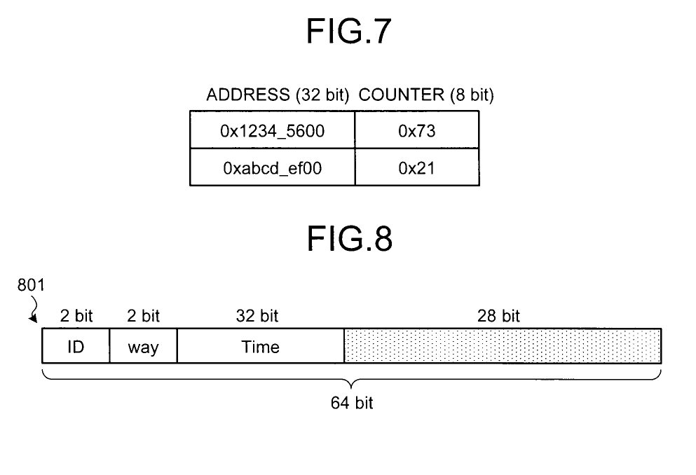

FIG. 7 is a diagram of an example of the internal structure of the target storing unit 602. The target storing unit 602 includes a section that stores the addresses set as the targets and counters corresponding to the stored addresses. The target storing unit 602 can store at least one address (in this embodiment, for example, two addresses). In the section that stores the addresses, 32 bits are secured for each of the addresses according to an address space. For each of the counters, for example, 8 bits are secured. The counter counts the number of pieces of access history information for each of the addresses set as the targets. A maximum of the number of bits of the counter is determined according to the following formula:

(A maximum of the number of bits of the counter)=(a cache capacity allocated to storage of the access history information)/(the number of addresses that can be set as targets)/(a data unit written by one access)

In the case of this embodiment, the cache capacity allocated to storage of the access history information is 2 megabytes, the number of addresses that can be set as targets is two, and the data unit written by one access is 8 bytes (64 bits). Because (2 megabytes)/2/(8 bytes)=256, the counter is set to 8 bits. The cache system 601 can store access history information of latest 256 times concerning access to the two addresses set as the targets.

For example, it is assumed that addresses “0x1234_{—}5600” and “0xabcd_ef00” are set as targets and the core 1 among the processor cores 101 accesses the address “0xabcd_ef00” in the debug mode. Further, it is assumed that a value of a counter is “0x73” concerning the address “0x1234_{—}5600” and a value of a counter is “0x21” concerning the address “0xabcd_ef00”.

In this embodiment, as in the first embodiments, cache access to the tag memory 1 and the data memory 1 is restricted. It is assumed that, as a result of comparing a tag of an accessed address and tags concerning ways read out from the tag memory 0, for example, the way 1 hits. In this case, cache data in an access address determined by an index number and a way number in the data memory 0 is accessed. Simultaneously with the access to the data memory 0, debug history information is written in the data memory 1.

FIG. 8 is a diagram of a format 801 for one word (a unit of one access) of the data memory 1 in the debug mode. The format 801 includes 64 bits. In the format 801, 2 bits are secured as ID bits, 2 bits are secured as way bits, and 32 bits are secured as time bits. The ID bits are bits for identifying the processor cores 101 at access sources. In this embodiment, as in the first embodiment, to identify the four processor cores 101 (0 to 3), 2 bits are secured as the ID bits. The way bits are bits for identifying a way at an access destination. In this embodiment, 2 bits are secured as the way bits to identify four ways (ways 0 to 3). The time bits indicate a numerical value of the timer 104 at the time of access. The history creating unit 112 creates, as debug history information, data of the ID bits, the tag bits, and the time bits in response to setting of a value of the debug mode register 103 to “1”. Among the 64 bits of the format 801, the remaining 28 bits are set as invalid bits.

In an example explained here, the data memory 1 is dividedly used for two addresses set as targets. For example, in the memory area of the data memory 1, one megabyte of a former half of the index is used for storage of debug history information in accessed to the address “0x1234_{—}5678” and one megabyte of a latter half of the index is used for storage of debug history information in access to the address “0xabcd_ef00”.

A position in which data is written in the data memory 1 is determined by a value of the counter for each of the addresses in the target storing unit 602. Debug history information by the access to the address “0xabcd_ef00” is written in a 0x21th field with respect to the value “0x21” of the counter concerning the address “0xabcd_ef00”. It is assumed that the memory area of one megabyte is a field for every 64 bits. Simultaneously with the writing of the access history information, the value of the counter concerning the address “0xabcd_ef00” is incremented from “0x21” to “0x22”.

When an address accessed from the processor cores 101 coincides with none of the addresses set as the targets, access history information is not stored. As in the first embodiment, the cache system 601 according to this embodiment can suppress an increase in cost and reduce time required for execution of debugging. Further, it is possible to store a large number of pieces of access history information concerning access to arbitrary set addresses and refer to access history information over a long period. This makes it possible to analyze a deficiency due to conflict between accesses at a large time interval.

The target storing unit 602 is not always provided separately from the other components included in the cache system 601. The target storing unit 602 can be stored in any one of the components included in the cache system 601. For example, in this embodiment, because a tag is not read out from the tag memory 1 in the debug mode, the target storing unit 602 can be stored in the tag memory 1. The number of addresses set as targets is not limited to two and only has to be equal to or larger than one.

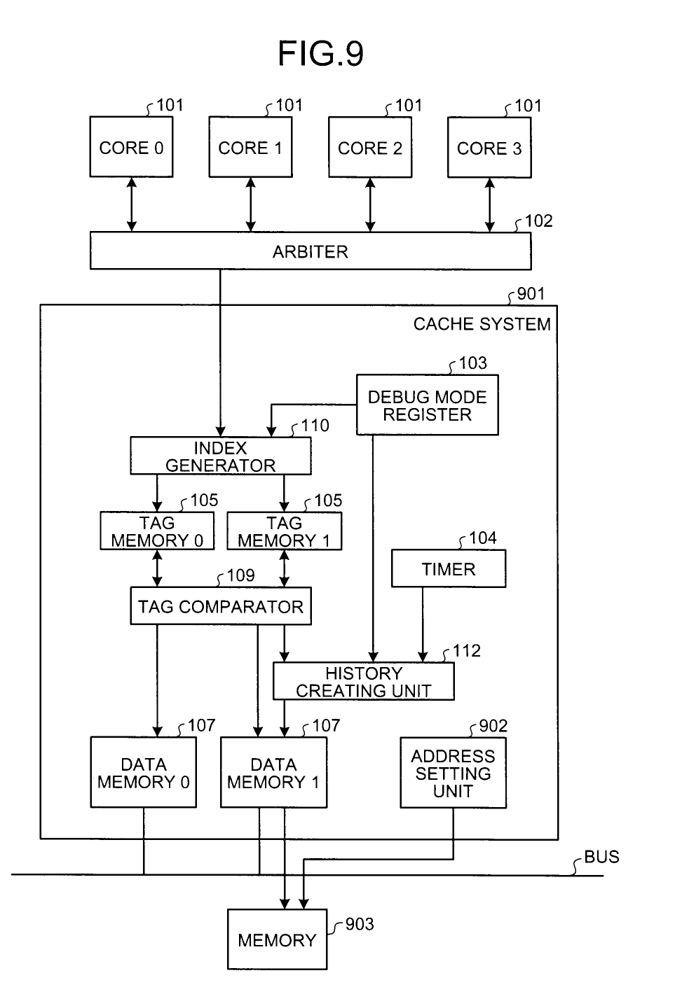

FIG. 9 is a block diagram of the configuration of a processor system including a cache system 901 according to a third embodiment of the present invention. The cache system 901 according to this embodiment saves access history information, which is stored in the data memory 1, in a memory 903 when a specific condition is satisfied. Components same as those in the first embodiment are denoted by the same reference numerals and signs and redundant explanation is omitted. The memory 903 as storing unit stores access history information output from the data memory 107. An address setting unit 902 sets an address in which the access history information is stored in the memory 903 and stores the set address.

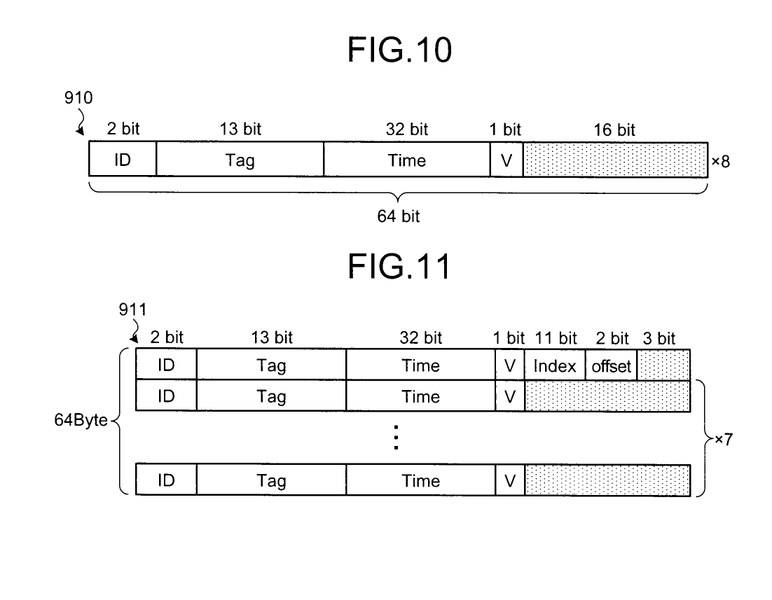

FIG. 10 is a diagram of a format 910 for one word (a unit of one access) of the data memory 1 in the debug mode. The format 910 includes a plurality of fields. In this embodiment, the format 910 includes, for example, eight fields 0 to 7. For example, 64 bits are allocated to each of the fields. In each of the fields, 2 bits are secured as ID bits, 13 bits are secured as tag bits, and 32 bits are secured as time bits. In addition to 3 bits, 1 bit is secured as a valid (V) bit.

The valid bit indicates whether data written in the field is valid as access history information. For example, when the valid bit is “0”, the access history information is written in the field. When the access history information is written in the field, “1” indicating that the data is valid as access history information is set in the valid bit.

When at least one of the following two conditions is satisfied, the cache system 901 saves the access history information in the memory 903 from the data memory 1:

(1) the access history information stored in the data memory 1 exceeds a limit capacity; and

(2) refill due to a cache miss occurs.

(1) means that, for example, the access history information is written in a field, a value of the counter of which is “7”, in the format 402 (see FIG. 4). In this case, when the value of the counter is incremented, the value is reset to “0” because digits are insufficient. New access history information is written over the access history information stored in the field. Therefore, the access history information of 64 byte stored in the data memory 1 is output to the memory 903 and the new access history information is written in the zeroth field 0.

(2) means that a valid cache line is invalidated because of a cache miss. In this case, because a cache line in which access history information is written is changed, pieces of access history information of accesses to addresses different from each other are stored in the same cache line. Therefore, the access history information of 256 bytes stored in the data memory 1 is output to the memory 903 and new access history information is written in the zeroth field 0.

In both (1) and (2), simultaneously with the saving of the access history information in the memory 903, all valid bits of saved fields are set to “0”. An address in which the access history information is written in the memory 903 is designated by the address setting unit 902. After the transfer of the access history information from the data memory 1 to the memory 903 ends, the address setting unit 902 adds an amount of access history information equivalent to transfer data in the address.

FIG. 11 is a diagram of a format 911 for one word (a unit of one access) in saving access history information in the memory 903 from the data memory 1. The format 911 includes a plurality of fields. In this embodiment, the format 911 includes, for example, eight fields 0 to 7. For example, 64 bits are allocated to each of the fields. In each of the fields, 2 bits are secured as ID bits, 13 bits are secured as tag bits, 32 bits are secured as time bits, and 1 bit is secured as a valid (V) bit.

Further, in the zeroth field, 11 bits are secured as index bits and 2 bits are secured as offset bits. The index bits and the offset bits indicate access history information of which address the format 911 is. In the debug mode, the index bits are 11 bits from an eighth bit to an eighteenth bit of an address. The offset bits represent positions in access units of 64 byte from the processor cores 101 in a 256-byte cache line. The offset bits are 2 bits of a sixth bit and a seventh bit of the address.

As in the first embodiment, the cache system 901 according to this embodiment can suppress an increase in cost and reduce time required for execution of debugging. Further, it is possible to refer to access history information over a long period by saving access history information according to the condition (1). This makes it possible to analyze a deficiency due to conflict between accesses at a large time interval irrespectively of an address to be accessed. It is possible to obtain access history information in cache line units rather than in index units by saving access history information according to the condition (2). This makes it possible to refer to more detailed access history information.

The cache system 901 according to this embodiment transfers access history information to the memory 903 only under a specific condition that satisfies at least one of (1) and (2). Therefore, it is possible to reduce an adverse effect on debugging execution time. The cache system 901 does not always adopt (1) and (2) as conditions for saving access history information from the data memory 1. The cache system 901 only has to adopt at least one of (1) and (2). The storing unit can be a main memory or the like connected via a bus besides the dedicated memory 903 that stores access history information.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cache system that can change a cache capacity in a unit of a plurality of divided memory areas, the cache system comprising a history creating unit that creates access history information concerning access in a debug mode, wherein
in the debug mode, cache access to at least one memory area among the divided memory areas is restricted and the access history information is stored in the memory area to which the cache access is restricted.

2. The cache system according to claim 1, further comprising an index generating unit that generates an index as a target of the cache access according to an accessed address, wherein
in the debug mode, the index generating unit generates an index in which a memory area other than the memory area to which the cache access is restricted is set as a target of the cache access.

3. The cache system according to claim 1, wherein
the cache system can set, as a target, at least one address in which the access history information is stored, and
in the debug mode, the access history information is stored in the memory area in response to access to the address set as the target.

4. The cache system according to claim 1, wherein the cache system saves, when the access history information stored in the memory area exceeds a limit capacity, the stored access history information in a storing unit.

5. The cache system according to claim 1, wherein the cache system saves, when the access history information is stored for each cache line and refill due to a cache miss occurs, the stored access history information in a storing unit.

6. The cache system according to claim 1, further comprising a data memory that is the memory area in which data is stored in cache line units, wherein
the access history information is written in a field included in a format of the data memory in the debug mode.

7. The cache system according to claim 1, further comprising a tag memory that is the memory area in which a tag is stored in cache line units, wherein
a counter that counts a number of pieces of the access history information is secured in a format of the tag memory in the debug mode.

8. A method of controlling a cache system that can change a cache capacity in a unit of a plurality of divided memory areas, the method comprising creating access history information concerning access in a debug mode, wherein
in the debug mode, cache access to at least one memory area among the divided memory areas is restricted and the access history information is stored in the memory area to which the cache access is restricted.

9. The method of controlling a cache system according to claim 8, further comprising
generating an index as a target of the cache access according to an accessed address; and
generating, in the debug mode, an index in which a memory area other than the memory area to which the cache access is restricted is set as a target of the cache access.

10. The method of controlling a cache system according to claim 8, wherein
the method can set, as a target, at least one address in which the access history information is stored, and
in the debug mode, the access history information is stored in the memory area in response to access to the address set as the target.

11. The method of controlling a cache system according to claim 8, further comprising saving, when the access history information stored in the memory area exceeds a limit capacity, the stored access history information in a storing unit.

12. The method of controlling a cache system according to claim 8, further comprising saving, when the access history information is stored for each cache line and refill due to a cache miss occurs, the stored access history information in a storing unit.

13. The method of controlling a cache system according to claim 8, further comprising storing data in cache line units in a data memory that is the memory area, wherein
the access history information is written in a field included in a format of the data memory in the debug mode.

14. The method of controlling a cache system according to claim 8, further comprising storing a tag in cache line units in a tag memory that is the memory area, wherein
a counter that counts a number of pieces of the access history information is secured in a format of the tag memory in the debug mode.

15. An information processing apparatus comprising a cache system that can change a cache capacity in a unit of a plurality of divided memory areas, wherein
the cache system includes a history creating unit that creates access history information concerning access in a debug mode, wherein
in the debug mode, cache access to at least one memory area among the divided memory areas is restricted and the access history information is stored in the memory area to which the cache access is restricted.

16. The information processing apparatus according to claim 15, wherein
the cache system further includes an index generating unit that generates an index as a target of the cache access according to an accessed address, and
in the debug mode, the index generating unit generates an index in which a memory area other than the memory area to which the cache access is restricted is set as a target of the cache access.

17. The information processing apparatus according to claim 15, wherein
the cache system can set, as a target, at least one address in which the access history information is stored, and
in the debug mode, the access history information is stored in the memory area in response to access to the address set as the target.

18. The information processing apparatus according to claim 15, wherein the cache system saves, when the access history information stored in the memory area exceeds a limit capacity, the stored access history information in a storing unit.

19. The information processing apparatus according to claim 15, wherein the cache system saves, when the access history information is stored for each cache line and refill due to a cache miss occurs, the stored access history information in a storing unit.
